(19) United States
(12) Patent Application Publication
(10) Pub. No.: US 2007/0052731 A1
(43) Pub. Date: Mar. 8, 2007

(54) Apparatus and method for correcting image distortion in display device

(75) Inventor: Sam Bong Bae, Gyeongsangnam-do (KR)

Correspondence Address: FLESHNER & KIM, LLP, P.O. BOX 221200, CHANTILLY, VA, 20153, US

(73) Assignee: LG Electronics Inc.

(21) Appl. No.: 11/318,586

(22) Filed: Dec. 28, 2005

(30) Foreign Application Priority Data
Sep. 6, 2005 (KR) 10-2005-0082788

(51) Int. Cl. G09G 5/00

(52) U.S. Cl. 345/647

(57) ABSTRACT

An apparatus for correcting image distortion in a display device and method thereof facilitate enhanced image distortion correction. The apparatus includes a first memory storing at least one interpolation constant; a control unit for generating a predetermined number of image point signals; a device for outputting at least one drive signal, to correct distortion in an image point, by interpolating the input image point signals using the at least one interpolation constant; and at least one switching device for switching a drive control of a corresponding area of the image in response to a corresponding drive signal.

This application claims the benefit of Korean Patent Application No. 10-2005-0082788, filed on Sep. 6, 2005, which is hereby incorporated by reference as if fully set forth herein.

### BACKGROUND OF THE INVENTION

1. Field of the Invention

The present invention relates to an apparatus for correcting image distortion in a display device and method thereof. Although the present invention is suitable for a wide scope of applications, it is particularly suitable for facilitating enhanced image distortion correction in a slim-type television receiver.

2. Discussion of the Related Art

As television receivers including a Braun tube (or cathode-ray tube) become slimmer, i.e., shallower depth, the deflection angle of the tube increases, which can cause severe image distortion, namely, non-linearity and pincushion effects. For example, the tube of a contemporary slim television receiver achieves an overall depth that is less, such that the deflection angle is greater, than the corresponding characteristics of a general Braun tube television receiver.

FIGS. 1A and 1B compare the overall depths of a general 32-inch television receiver (60 cm) and a contemporary 32-inch “super-slim” television receiver (39 cm), while FIG. 1C illustrates the difference in deflection angles between a general Braun-tube television receiver (110°) and a “super-slim” television receiver (125°). Accordingly, image distortion suffers in slimmer television receivers, which have tube depths as much as 20 cm less than in general television receivers.

According to FIG. 2, which is representative of an image having a simple crosshatch pattern, where the horizontal divisions along any row should be uniform, that is, a=b=c=d=e=f= . . . . Here, correction of (horizontal) linearity distortion aims to render equal-width horizontal divisions in the received/displayed image, and correction of pincushion distortion, in which vertical lines are bowed rather than straight, is achieved using an east-west (EW) waveform. Specifically, horizontal image size can be controlled by varying a DC value of the EW waveform, while pincushion effects can be overcome by controlling an AC value of the EW waveform.

Referring to FIG. 3, a general display device comprises a deflection controller 1 for generating and outputting an EW correction waveform, a deflection circuit 2 for performing vertical and horizontal deflection control according to the EW correction waveform, an inner correction circuit 3 for adjusting image distortion control by the deflection circuit, a deflection yoke (DY) 4, and a cathode-ray tube (CRT) 5. The deflection yoke 4 includes four transistors for respectively driving a corresponding area of the image display, and the inner correction circuit 3 includes a variable resistor for each transistor of the deflection yoke, such that adjusting the value of a variable resistor determines the timing (turn-on time) of the corresponding transistor.

FIGS. 4A-4D illustrate the above adjustment, whereby each graph shows a transistor-on waveform for one of the above four transistors, with each transistor exhibiting a different turn-on time with respect to a reference waveform. FIG. 4E shows the combined effect of four image distortion correction signals CS1-CS4, corresponding to the four transistor turn-on waveforms of FIGS. 4A-4D, which are used in correcting linearity distortion and pincushion distortion.

Although linearity and pincushion corrections can be achieved using a conventional techniques, namely, a linearity coil and EW waveform, such image correction through a single corrective action is impractical for slimmer cathode-ray tubes. Instead, each displayed image is divided into four areas, which are respectively controlled by a switching pulse from one of the transistors, and the correction is performed for each area, which necessitates an interactive adjustment of each transistor's turn-on time. The four variable resistors are included in an inner-pin correction circuit employed for the display device. While pincushion distortion can be corrected using correction waveforms (EW waveforms), linearity correction is carried out by an adjustment of the variable resistors. This adjustment is a complex operation typically performed by a user who manually adjusts the variable resistors mounted on a substrate and, as a result, often leads to an inaccurate image distortion correction of top, bottom, right, and left parts of the image display.

### SUMMARY OF THE INVENTION

Accordingly, the present invention is directed to an apparatus for correcting image distortion in a display device and method thereof that substantially obviates one or more problems due to limitations and disadvantages of the related art.

An object of the present invention is to provide an apparatus for correcting image distortion in a display device and method thereof, by which enhanced image distortion correction is facilitated.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages in accordance with the purpose of the invention, as embodied and broadly described herein, there is provided an apparatus for correcting image distortion. The apparatus comprises memory storing at least one interpolation constant; device for outputting at least one drive signal, to correct distortion in an image, by interpolating an input image signal using the at least one interpolation constant; and at least one switching device for switching a drive control of a corresponding area of the image in response to a corresponding drive signal.

In another aspect of the present invention, there is provided an apparatus for correcting image distortion. The apparatus comprises a first memory storing at least one interpolation constant; a control unit for generating a predetermined number of image point signals; device for outputting at least one drive signal, to correct distortion in an image point, by interpolating the input image point signals using the at least one interpolation constant; and at least one switching device for switching a drive control of a corresponding area of the image in response to a corresponding drive signal.

In another aspect of the present invention, there is provided a method of correcting image distortion in a display device provided with memory. The method comprises calculating at least one interpolation constant required for interpolation; storing in memory the at least one interpolation constant; and generating at least one drive signal, to correct distortion in an image, by interpolating at least one input point signal of the image using the at least one interpolation constant.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1A is a diagram showing the overall length of a general 32-inch television receiver;

FIG. 1B is a diagram showing the overall length of a contemporary 32-inch “super-slim” television receiver;

FIG. 1C is a diagram illustrating the deflection angles of a general Braun tube television receiver and a “super-slim” television receiver;

FIG. 2 is a diagram of an exemplary image having a crosshatch pattern;

FIG. 3 is a block diagram of a general display device;

FIGS. 4A-4D are a series of graphs of transistor-on waveforms as controlled by the four variable resistors included in an inner-pin correction circuit, each of the four transistors exhibiting a different turn-on time with respect to a reference waveform;

FIG. 4E is a graph of a waveform generated from the waveforms of FIGS. 4A-4D;

FIG. 5 is a block diagram of an apparatus for correcting image distortion in a display device according to an embodiment of the present invention;

FIG. 6 is a detailed block diagram of a drive signal outputting device shown in FIG. 5;

FIGS. 7A-7D are diagrams illustrating the correction of an output video signal to be displayed;

FIG. 8 is an exemplary diagram of linear interpolation;

FIG. 9 is an exemplary diagram of Hermit interpolation;

FIG. 10 is a diagram for explaining a method of correcting linearity distortion and pincushion distortion according to the embodiment of the present invention; and

FIGS. 11A-11C are pictures of actual pincushion effects and correction conditions, including OSD data, where sixteen points are selected for the correction.

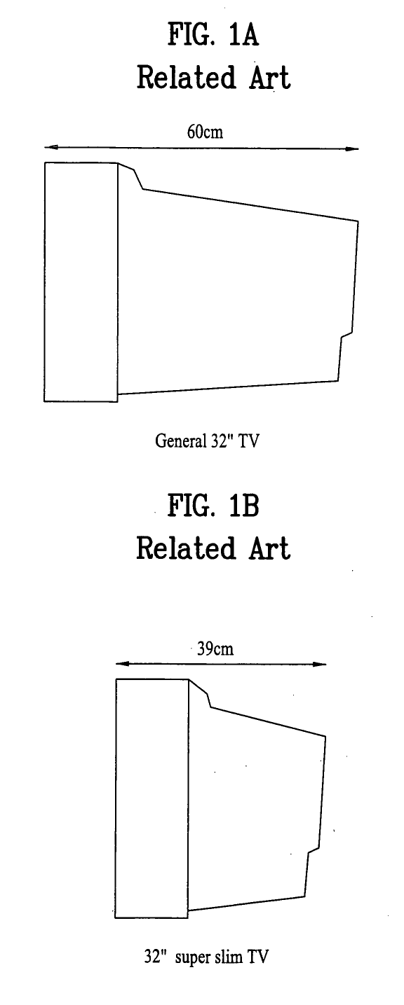

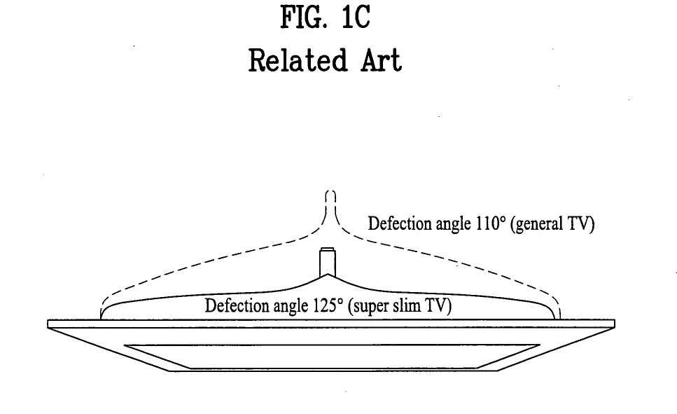

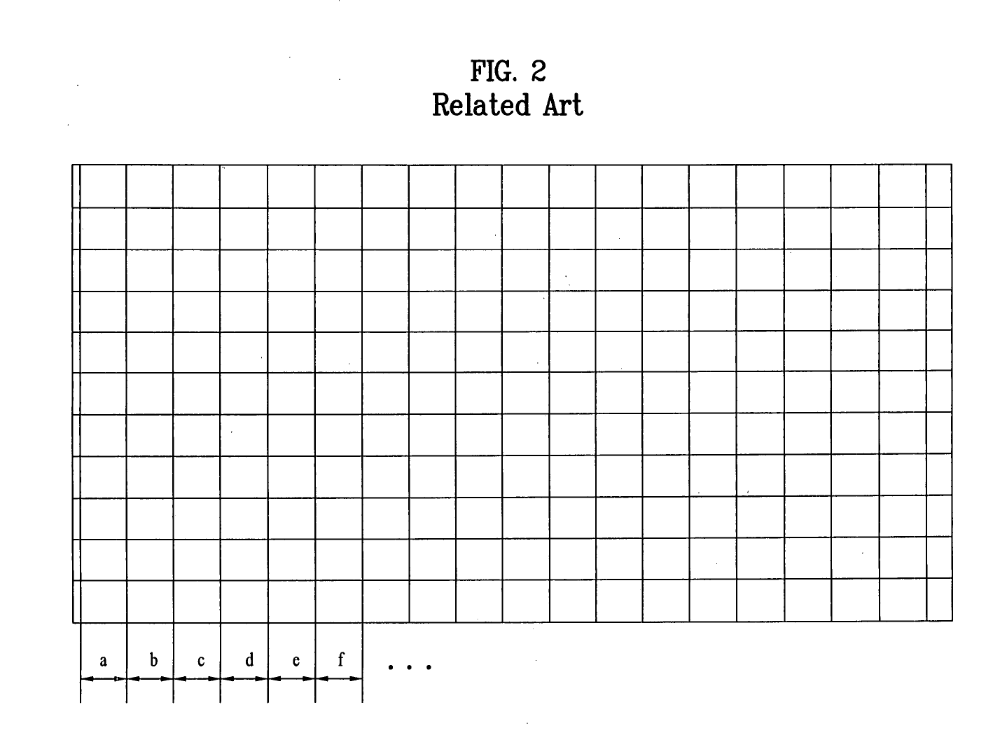

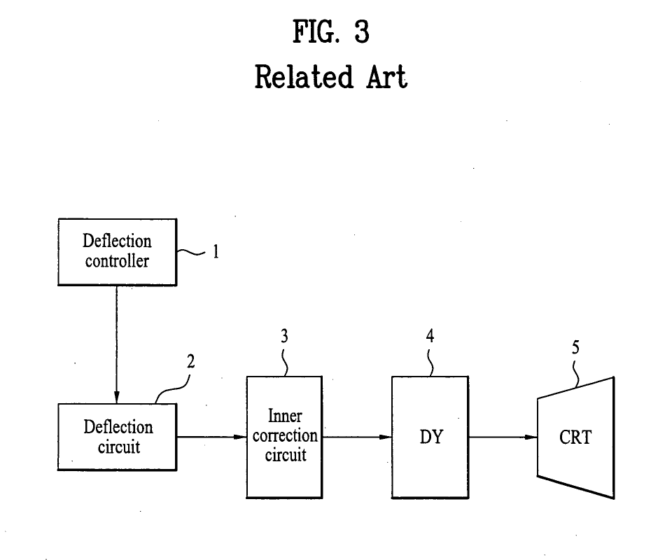

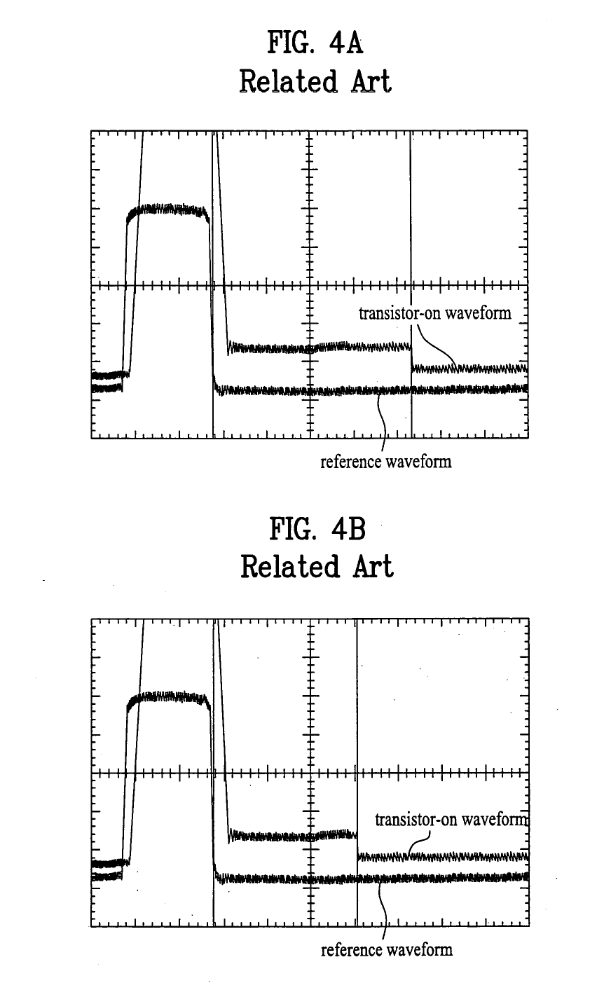

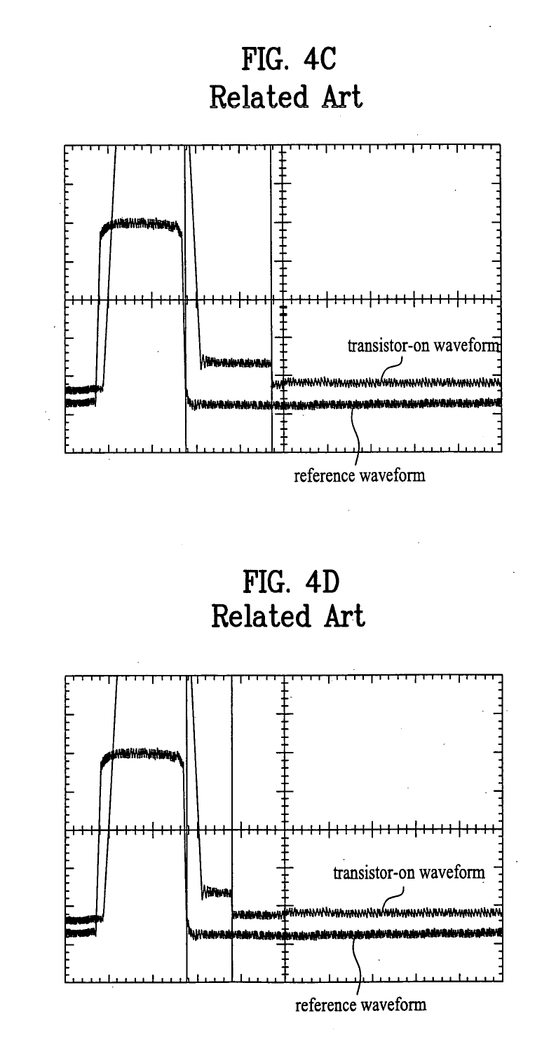

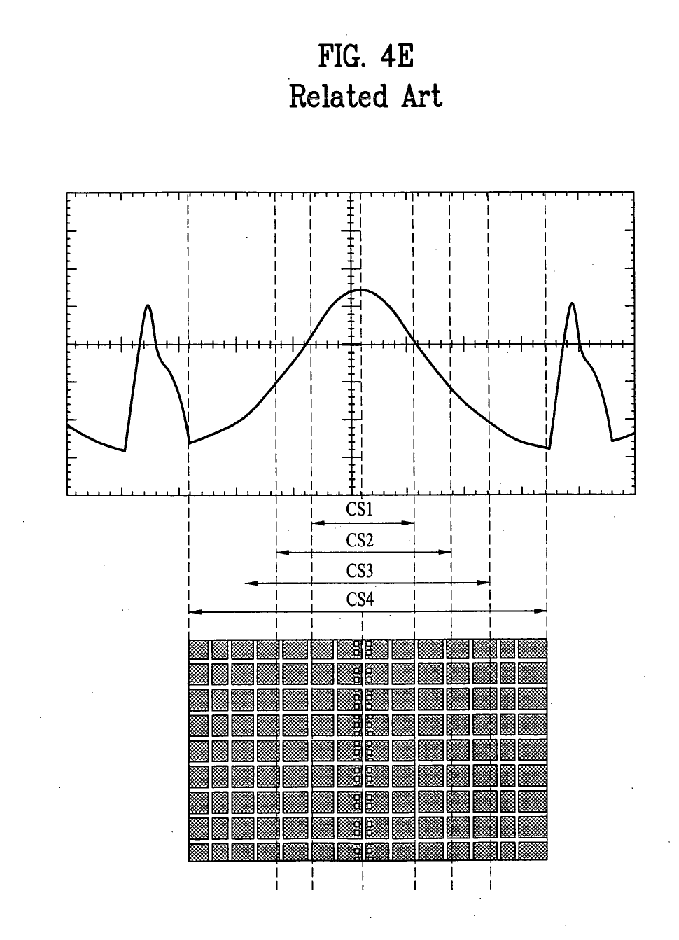

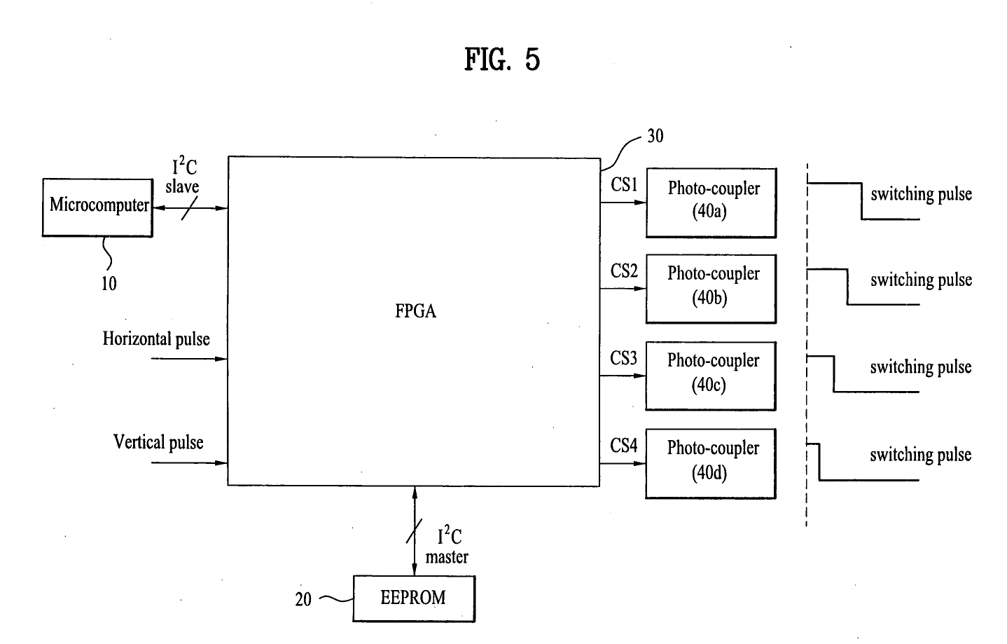

### DETAILED DESCRIPTION OF THE INVENTION

Reference will now be made in detail to the preferred embodiments of the present invention, examples of which are illustrated in the accompanying drawings. Wherever possible, like reference designations will be used throughout the drawings to refer to the same or similar parts.

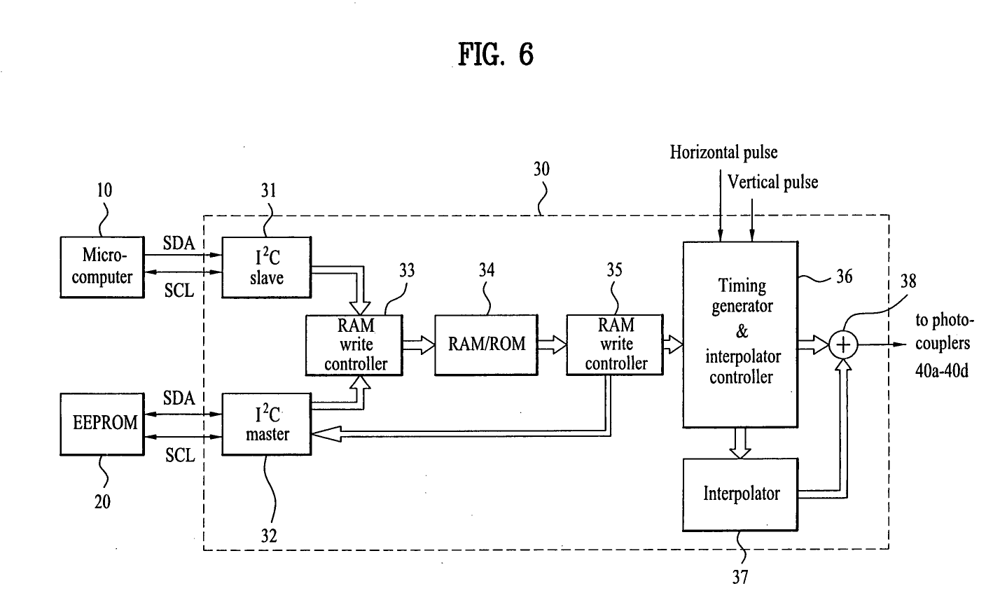

FIG. 5 illustrates an apparatus for correcting image distortion according to the present invention, including a field-programmable gate array (FPGA) as a drive signal outputting device, which is shown in FIG. 6. The apparatus of FIG. 5 is applicable to a slim-type television receiver, so that inaccurate user (i.e., manual) adjustments can be prevented by generating multiple transistor drive signals using a programmable logic device, i.e., the FPGA.

Referring to FIG. 5, the apparatus of the present invention includes a microcomputer 10 as a control unit for generating a predetermined number of image point signals; an EEPROM 20 as a first memory storing at least one interpolation constant (the number of constants being for sixteen-point adjustment, in the present embodiment); a field-programmable gate array 30 as a device for generating one or more drive signals (four drive signals CS1-CS4, in the present embodiment) to correct distortion in an image; and a plurality of photo-couplers 40a-40d as switching devices for respectively outputting the drive signals, each of which switches a drive control of a corresponding area of each image in response to the corresponding drive signal and are thus equal in number (four, in the present embodiment) to the drive signals. The interpolation constant is a linear interpolation constant or a Hermit interpolation constant, and the image distortion is a pincushion and non-linearity distortion. The image point signals are line signals selected for image distortion correction, and in the present embodiment, there are three or sixteen line signals selected according to an area of each image, though the number of the correction lines can be arbitrarily selected.

In the embodiment of the present invention, the image is divided into four areas but can be divided into any number of such areas. Hence, the number of drive signals and switching devices may correspond to a number of pulse waveforms and a number of transistors, respectively, equaling the number of area divisions. The transistor may be a CMOS FET or bipolar transistor.

The field-programmable gate array 30 is ASIC-programmed to provide transistor switching pulses for respectively performing parabola controls, and as shown in FIG. 6, includes a slave unit 31 for communicating with the control unit to input the point signals; a master unit 32 for performing read/write operations with respect to the first memory; a first RAM write controller 33 for controlling write operations using data from the slave and master units 31 and 32; a RAM/ROM 34 as a second memory for storing, in table form, the data from the slave and master units by a control of the first RAM write controller 33; a second RAM write controller 35 for controlling the master unit and for controlling write operations using data from the RAM/ROM; a timing generator and interpolator controller 36 for generating a timing signal using input vertical and horizontal (pulse) sync signals and for controlling the interpolation; an interpolator as an arithmetic logic unit for providing a plurality of correction signals CS1-CS4 by performing interpolation on the point signals output by the timing generator and interpolator controller based on the interpolation constants; and an adder 38 for outputting distortion-corrected (final) drive signals by summing the correction signals and the point signals. The correction signals CS1-CS4 correspond to “on” signals of the switching devices, which are in effect adjustment signals acting on the sixteen points.

In the correction apparatus of the present invention, at least one interpolation constant necessary for the interpolation is calculated by a manufacturer and stored in a memory of a display device. The point signals of each image, which are input from the control unit 10, are interpolated with the at least one interpolation constant, to generate at least one drive signal enabling a distortion correction of each image. Each drive signal is used in driving the switching device for the corresponding area of the respective images. Thus, the manufacturer can select three or sixteen lines according to image area from among about 540 (the number of lines in one field) scan lines constructing each image, to perform a correction operation based on the selected lines only, i.e., without using all 540 scan lines in performing correction. Meanwhile, the unselected lines between the selected lines are interpolated by the interpolation process to generate the complete correction signal.

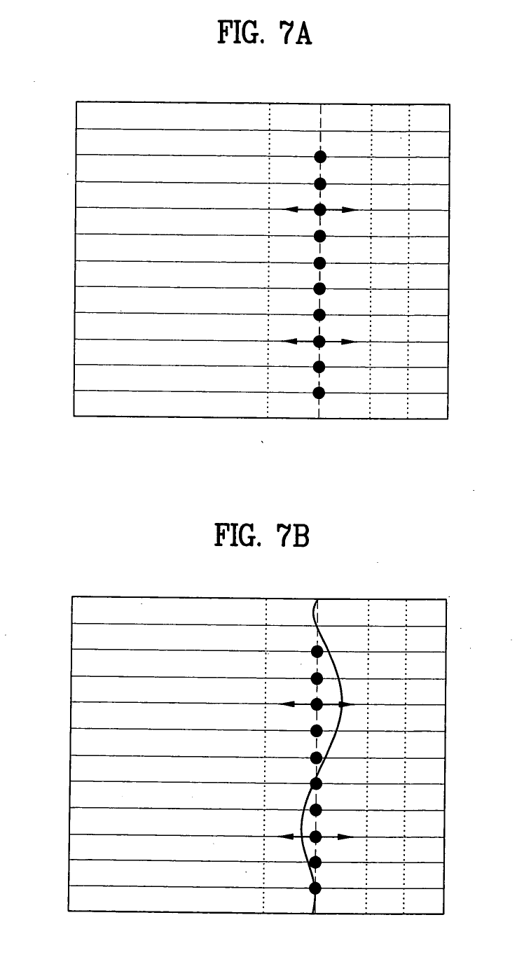

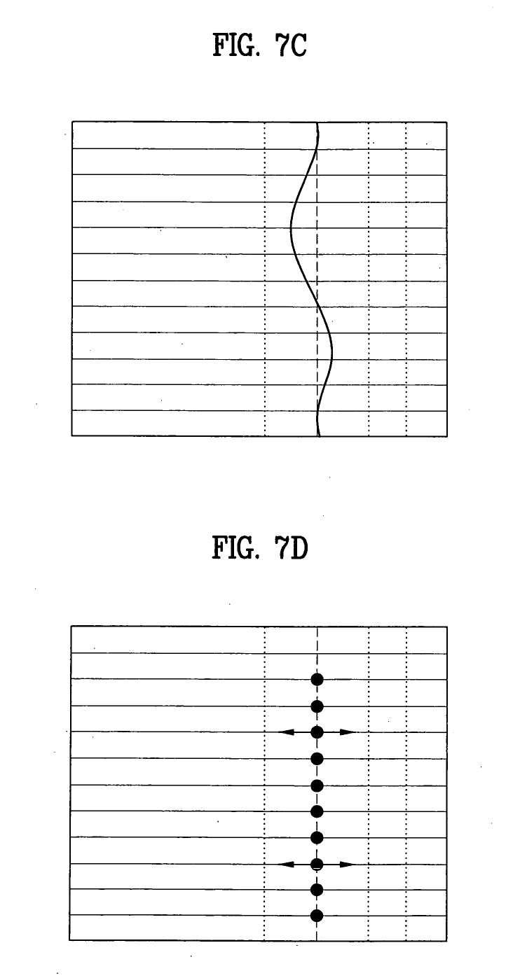

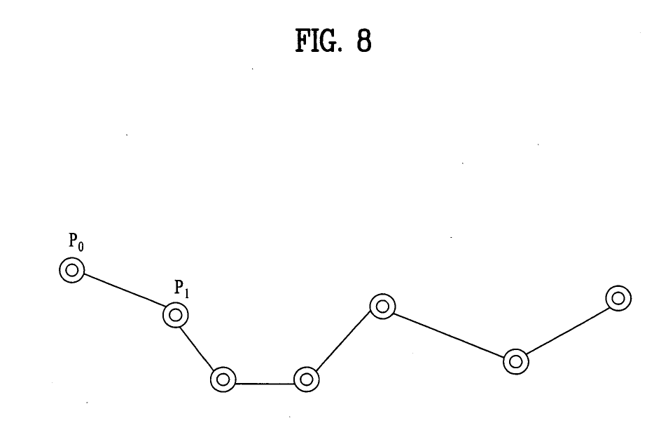

FIGS. 7A-7D diagram an interpolation concept according to an embodiment of the present invention, where FIG. 7A shows an output video signal, FIG. 7B shows the video signal with an uncorrected image, FIG. 7C shows a correction signal from the field-programmable gate array 30, and FIG. 7D shows the ultimately corrected video signal. The correction signal is a signal for correcting linearity distortion and pincushion distortion of the displayed video signal.

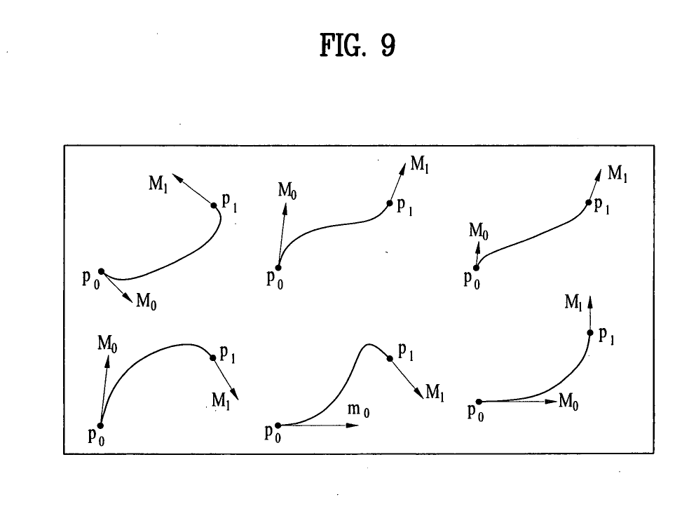

The main function of the drive signal outputting device, i.e., the field-programmable gate array 30, is to calculate values of unknown points between the selected points (lines) using several given data, i.e., the three or sixteen selected point signals according to the corresponding area. This calculation process is called interpolation, and the present invention employs two kinds of interpolation schemes: linear interpolation, which is diagramed in FIG. 8, and Hermit interpolation, which is diagramed in FIG. 9. In the linear interpolation of FIG. 8, where first (start) and second (end) points have values of P₀and P₁, respectively, the value of a specific point P(t) is found by Equation 1.
P(t)=P₀+t(P₁−P₀) Equation 1

Linear interpolation is advantageous in terms of implementation but the required degree of quality in the results is difficult. Hermit interpolation, on the other hand, can achieve the required quality of results but application of a tertiary equation as necessary is needed, which complicates implementation. Thus, in the Hermit interpolation of FIG. 9, for tangent components of the start and end points (P₀, P₁) of M₀ and M₁, respectively, the value of the specific point P(t) is found by Equation 2.
P(t)=P₀(2t³−3t²+1)+M₀(t³−2t²+t)+M₁(t³−t²)+P₁(−2t³+3t²) Equation 2

To perform a Hermit interpolation algorithm, the above maximum tertiary equation should be computed for each line of each image. The difficulty in implementing the tertiary equation with only a logic circuit necessitates that constant values, required for the Hermit interpolation, be previously calculated and stored in the EEPROM 20 (the first memory), such that the Hermit interpolation is performed by reading from the memory the necessary constant values for each line.

For instance, if sixteen points are selected for the interpolation from among 540 points of each image, the sixteen points are interpolated to give the 540 lines of one field. In this case, Hermit interpolation is carried out by Equation 3.

$$\begin{matrix}P ( t ) = {P}_{0} ( 2 {t}^{3} - 3 {t}^{2} + 1 ) + {M}_{0} ( {t}^{3} - 2 {t}^{2} + t ) + \\ {M}_{1} ( {t}^{3} - {t}^{2} ) + {P}_{1} ( - 2 {t}^{3} + 3 {t}^{2} ) \\ = {P}_{0} ( 2 {t}^{3} - 3 {t}^{2} + 1 ) + ( {P}_{1} - {P}_{0} ) ( {t}^{3} - 2 {t}^{2} + t ) + \\ ( {P}_{2} - {P}_{1} ) ( {t}^{3} - {t}^{2} ) + {P}_{1} ( - 2 {t}^{3} + 3 {t}^{2} ) \\ = {P}_{0} ( {t}^{3} - {t}^{2} - t + 1 ) + {P}_{1} ( - 2 {t}^{3} + 2 {t}^{2} + t ) - {P}_{2} ( - {t}^{3} + {t}^{2} )\end{matrix} \qquad Equation 3$$

where each of t³−t²−t+1, −2t³+2t²+t, and −t³+t² are constants (C₀, C₁, C₂).

As another example, if three points are selected for the interpolation from among the 540 points of each image, the three points are preferentially interpolated to give sixteen points and are then again interpolated to give 540 lines (points). In this instance, the Hermit interpolation is performed by Equation 4, where the intermediate variables (M₀, M₁) of Equation 3 are set to zero.

$$\begin{matrix}P ( t ) = {P}_{0} ( 2 {t}^{3} - 3 {t}^{2} + 1 ) + {M}_{0} ( {t}^{3} - 2 {t}^{2} + t ) + \\ {M}_{1} ( {t}^{3} - {t}^{2} ) + {P}_{1} ( - 2 {t}^{3} + 3 {t}^{2} ) \\ = {P}_{0} ( 2 {t}^{3} - 3 {t}^{2} + 1 ) + {P}_{1} ( - 2 {t}^{3} + 3 {t}^{2} )\end{matrix} \qquad Equation 4$$

where each of 2t³−3t²+1 and −2t³+3t² are constants (C₀, C₁).

The constants of Equations 3 and 4 are previously calculated and stored in the EEPROM 20 in a table form.

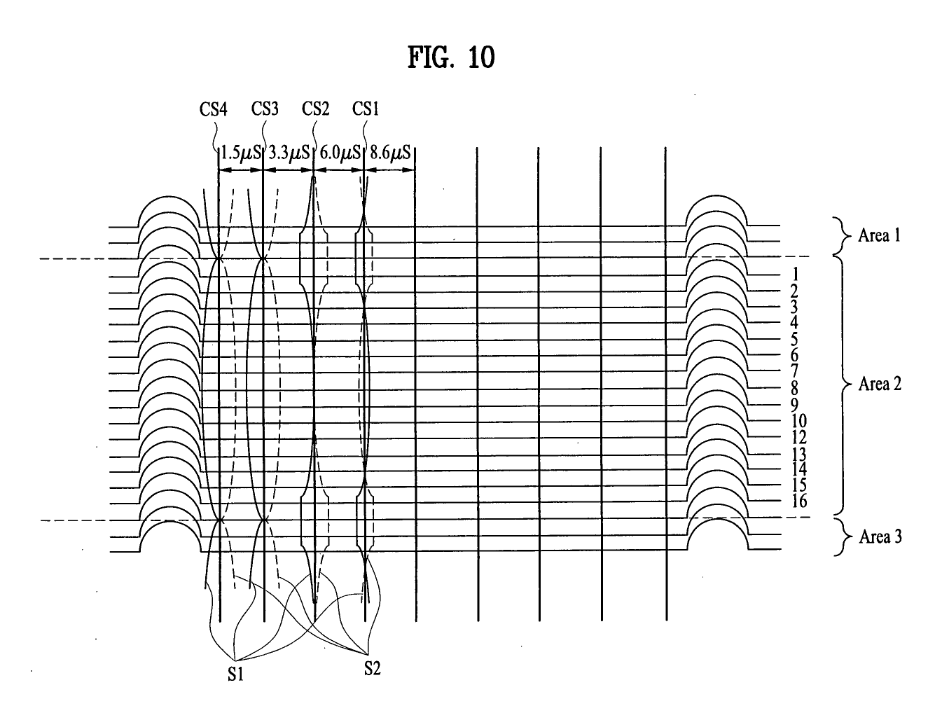

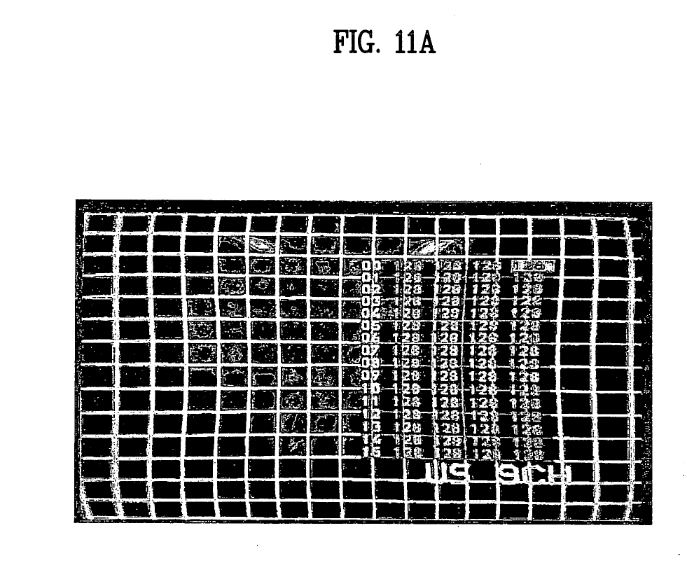

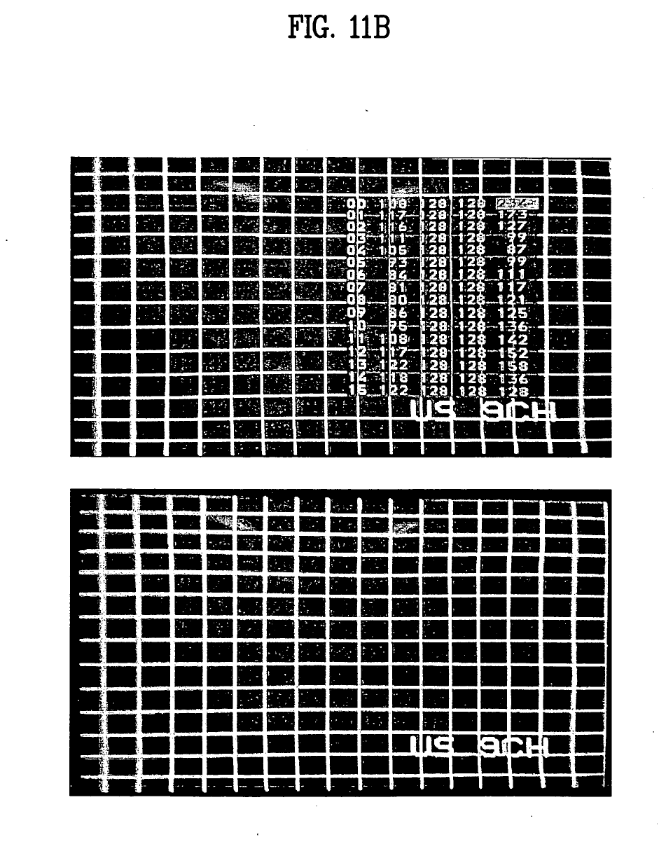

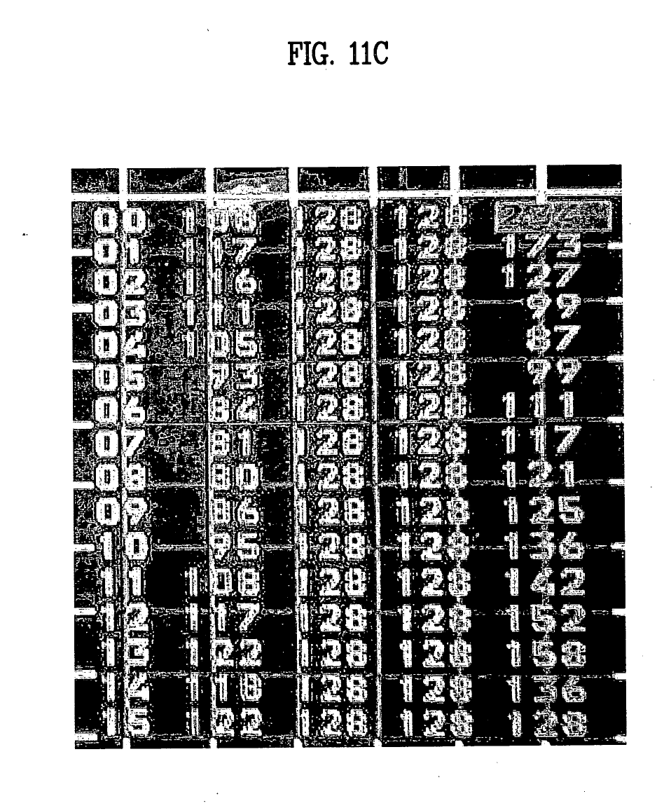

FIGS. 10 and 11 illustrate a correcting of linearity distortion and pincushion distortion using sixteen selected points according to the method of the present invention, with FIG. 11A showing actual pincushion effects on an image, i.e., prior to correcting using the sixteen selected points, and FIG. 11B showing the pincushion conditions achieved after correction. FIG. 11C specifically details the on-screen display (OSD) data for the correction shown in FIG. 11B.

Referring to FIG. 10, each of the final drive signals CS1-CS4, which are output from the field-programmable gate array 30 after distortion is corrected, appear as a straight line because the distortion has been corrected. Waveforms S1 are drive signals actually appearing on an image without being corrected and have distorted forms, and waveforms S2 are correction waveforms output to the adder 38 from an interpolator 37. The final drive signals CS1-CS4 are separated by intervals of 1.5 μs, 3.3 μs, 6.0 μs, and 8.6 μs, respectively. Here, the image is divided into three areas, namely, Areas 1, 2, and 3, and three points (or horizontal lines) are selected for the distortion correction from Areas 1 and 3, while sixteen points are selected from Area 2. In other words, each of the drive signals, which is a horizontal pulse, obtains the correction waveform from points between the respective points through an interpolation by way of a sequential varying of the sixteen points in Area 2. Hence, the vertical (column) lines of the image can be corrected, i.e., to remove distortion, such that for each of Areas 1 and 3, the interpolation is carried out by moving three points only, in the same manner, to find the correction waveforms and to correct the vertical lines.

By adopting the apparatus and method of the present invention, the turn-on time of the transistors can be precisely controlled using programmable logic means. In addition, the need for substrate adjustments, which are often inaccurate, can be obviated using an interpolation scheme, thereby preventing adjustment errors.

It will be apparent to those skilled in the art that various modifications can be made in the present invention without departing from the spirit or scope of the invention. Thus, it is intended that the present invention covers such modifications provided they come within the scope of the appended claims and their equivalents.

What is claimed is:

1. An apparatus for correcting image distortion, comprising:
memory storing at least one interpolation constant;
device for outputting at least one drive signal, to correct distortion in an image, by interpolating an input image signal using the at least one interpolation constant; and
at least one switching device for switching a drive control of a corresponding area of the image in response to a corresponding drive signal.

2. The apparatus of claim 1, wherein the at least one interpolation constant is a linear interpolation constant.

3. The apparatus of claim 1, wherein the at least one interpolation constant is a Hermit interpolation constant.

4. The apparatus of claim 1, wherein the image is divided into a plurality of areas, wherein the at least one drive signal is a number of pulse waveforms equal in number to the area divisions, and wherein said at least one switching device is a number of transistors equal in number to the area divisions.

5. The apparatus of claim 1, wherein each of the at least one drive signal is output from said drive signal outputting device via a photo-coupler.

6. The apparatus of claim 1, wherein said memory is an EEPROM.

7. An apparatus for correcting image distortion, comprising:
a first memory storing at least one interpolation constant;
a control unit for generating a predetermined number of image point signals;
device for outputting at least one drive signal, to correct distortion in an image point, by interpolating the input image point signals using the at least one interpolation constant; and
at least one switching device for switching a drive control of a corresponding area of the image in response to a corresponding drive signal.

8. The apparatus of claim 7, wherein the distortion is at least one of pin-cushioning and non-linearity.

9. The apparatus of claim 7, wherein the image point signals are line signals selected for correcting the image distortion.

10. The apparatus of claim 9, wherein the line signals are selected according to an area of the image.

11. The apparatus of claim 10, wherein the area of the image corresponds to one selection of three line signals and sixteen line signals.

12. The apparatus of claim 7, wherein said drive signal outputting device is a field-programmable gate array that is an ASIC-programmable logic means.

13. The apparatus of claim 7, said drive signal outputting device comprising:
a slave unit for communicating with said control unit to input the image point signals;
a master unit for performing read/write operations with respect to the first memory;
a first write controller for controlling a write of data from the slave and master units;
a second memory for storing the data from said slave unit and said master unit in a table form by a control of said first write controller;
a second write controller for controlling said master unit and for controlling a write operation for data from said second memory;
a timing generator and interpolator controller for generating a timing signal using input vertical and horizontal sync signals and for controlling the interpolation of the input image point signals;
an interpolator for outputting at least one correction signal by performing interpolation on the point signals output by said timing generator and interpolator controller based on the interpolation constants; and
an adder for outputting distortion-corrected drive signals by summing the at least one correction signal and the point signals.

14. The apparatus of claim 13, wherein the second memory is one of a RAM and a ROM.

15. The apparatus of claim 13, wherein the interpolator is an arithmetic logic unit.

16. The apparatus of claim 13, wherein each of said first and second write controllers are RAM write controllers.

17. A method of correcting image distortion in a display device provided with memory, comprising:
calculating at least one interpolation constant required for interpolation;
storing in memory the at least one interpolation constant; and
generating at least one drive signal, to correct distortion in an image, by interpolating at least one input point signal of the image using the at least one interpolation constant.

18. The method of claim 17, wherein each of the drive signals is used in driving a switching device for a corresponding area of the image.

19. The method of claim 17, wherein the image point signals are line signals selected for correcting the image distortion.

20. The method of claim 19, wherein the line signals are selected according to an area of the image.

21. The method of claim 20, wherein the area of the image corresponds to one selection of three line signals and sixteen line signals.

22. The method of claim 17, wherein the at least one interpolation constant is a linear interpolation constant.

23. The method of claim 17, wherein the at least one interpolation constant is a Hermit interpolation constant.

24. The method of claim 17, wherein the image is divided into a plurality of areas and wherein each drive signal is a pulse waveform.
